(19) United States
(12) Patent Application Publication
(10) Pub. No.: US 2007/0259778 A1
(43) Pub. Date: Nov. 8, 2007

(54) FLAMELESS HEATING SYSTEM

(75) Inventors: James Spencer, Fayetteville, NY (US); Randy Rarig, Syracuse, NY (US)

Correspondence Address: BOND, SCHOENECK & KING, PLLC, ONE LINCOLN CENTER, SYRACUSE, NY, 13202-1355, US

(73) Assignee: SYRACUSE UNIVERSITY, Syracuse, NY (US)

(21) Appl. No.: 11/742,545

(22) Filed: Apr. 30, 2007

Related U.S. Application Data
(60) Provisional application No. 60/745,874, filed on Apr. 28, 2006.

(51) Int. Cl. B01J 21/02

(52) U.S. Cl. 502/202

(57) ABSTRACT

A flameless heating system comprising the mixture of solid state titanium boride materials with a solution of hydrogen peroxide. A small amount of solid titanium boride in the form of a tablet, powder, or thin film is added to an aqueous peroxide solution. After addition of the solid titanium boride to the aqueous peroxide solution, a significant amount of heat is released to the surroundings. As the mixture of solid titanium boride to the aqueous peroxide solution often forms a gel, the mixture provides self-regulated amounts of heat.

### CLAIM PRIORITY

The present application claims priority to U.S. Provisional Patent Application Ser. NO. 60/745,874, filed Apr. 28, 2006, the entirety of which is hereby incorporated by reference.

### BACKGROUND OF THE INVENTION

1. Field of the Invention

The present invention relates to flameless heating systems and, more specifically, to a heating system including solid state titanium boride and hydrogen peroxide.

2. Description of the Related Art

New technological solutions to provide safe, convenient, lightweight, and efficient flameless heating technologies are in demand for a variety of applications, especially where safe, convenient and inexpensive heat sources are required at field and in remote locations. For example, several flameless heating technologies have been developed, such as the system employed by the Army to warm field rations require sufficiently for consumption in the field. Flameless heat sources are required to be lightweight, inexpensive, safe and conveniently operated and disposed of in the field, as well as being able to deliver sufficient heat for a significant time. Existing Army technologies are based upon magnesium and iron based chemical heating units that have been adapted for use in heating. Typically, 2.5% saline solutions (˜350 g) are used to activate the Mg-Fe chemical system (˜130 g) that provides sufficient heat to raise the temperature of the ration to 140° F. over 40 minutes. This system has the advantages of a self-regulating unit that delivers a high heat density with a relatively high energy to weight ratio. There are, however, significant problems associated with the use of these types of heating systems. Most important among these problems with the Mg-Fe systems are regulatory restrictions arising from the flammability, transportation, storage and disposal of the components. Additionally, the premature activation of the heater from inadvertent contact with the activator solution or the food itself is problematic. Other flameless heating technologies also have significant limitations regarding cost, stability, self-regulation and disposal of the units after use.

### SUMMARY OF THE INVENTION

It is therefore a principal object and advantage of the present invention to provide an inexpensive heating system.

It is another object and advantage of the present invention to provide a uniformly distributed heating system.

It is a further object and advantage of the present invention to provide a non-toxic heating system.

It is an additional object and advantage of the present invention to provide a non-flammable heating system.

It is another object and advantage of the present invention to provide a lightweight heating system.

It is a further object and advantage of the present invention to provide an easy to use heating system.

It is an additional object and advantage of the present invention to provide an environmentally friendly heating system.

Other objects and advantages of the present invention will in part be obvious, and in part appear hereinafter.

In accordance with the foregoing objects and advantages, the present invention provides flameless heating technologies based upon the use of the readily controlled exothermic reaction of hydrogen peroxide solutions catalyzed by solid state titanium boride materials. This new system is inexpensive and can be easily regulated to provide significant amounts of heat that may be uniformly distributed through the formation of an inert gel (ΔH=1493 kJ/mol). The titanium boride-peroxide systems, therefore, form the core components of a new heater system that is inexpensive, safe to operate, portable, lightweight, easy to use, and easily disposed of in an environmentally friendly manner. In addition, these systems can be designed to provide continuous heat over an extended period. This new system is based upon the catalytic reaction chemistry of solid state titanium boride materials with hydrogen peroxide solutions to form a readily regulated heat supply. This new flameless heating system will be very inexpensive, provide for safe use, storage and disposal, along with other desirable operational features.

### BRIEF DESCRIPTION OF THE DRAWINGS

The present invention will be more fully understood and appreciated by reading the following Detailed Description in conjunction with the accompanying drawings, in which:

FIG. 1 is a micrograph of thin film titanium boride coating prepared according to the present invention.

FIG. 2 is scanning electron micrograph of boride particles formed by aerosol methods according to the present invention.

FIG. 3 is a graph of the heating profile of heating a hydrogen peroxide and titanium boride solution according to the present invention.

FIG. 4 is another graph of the heating profile of heating a hydrogen peroxide and titanium boride solution according to the present invention.

FIG. 5 is a further graph of the heating profile of heating a hydrogen peroxide and titanium boride solution according to the present invention

### DETAILED DESCRIPTION

Referring now to the drawings, wherein like reference numerals refer to like parts throughout, the basis for the present invention is the catalytic action of solid state titanium boride materials upon solutions of hydrogen peroxide. A small amount of solid titanium boride (as a tablet, powder, or thin film) added to an aqueous peroxide solution will release significant, self-regulated, amounts of heat to the surroundings. In addition, under specific conditions, a gel can be formed in the reaction mixture.

The fundamental exothermic energy production arises primarily from the catalytic action of titanium boride upon peroxide solutions. The overall chemical process is given by:
H₂O₂(aq) ------>H₂O+0.5 O₂ (incorporated into TiB₂ gel) ΔH=1380 Btu/lb
This exothermic decomposition is, however, not a spontaneous process and requires the presence of a catalyst in order to proceed.

A few catalysts for this process are known, most notably platinum metal. The present invention, however, involves the use of a titanium boride, which is a remarkably efficient catalyst for the process of the present invention. In connection with the present invention, the catalyst is provided by adding a small amount of titanium boride solid as a pellet, powder, or thin film coating on a substrate to the solution. Under some conditions, a gel may be formed in the reaction mixture. The gel is presumably a cross-linked titanium-boride-oxide material that is both thermally self-regulating and highly exothermic (ΔH=1493 kJ/mol based upon titanium boride). In cases where a gel is formed, the formation of the gel helps control the gas evolution and the O₂ remains within the gel matrix. The gel also evenly distributes the heat throughout the sample and over time, leading to an efficient heating system.

The use of titanium boride solids with peroxide solutions in the operation of the proposed flameless heating unit provides significant advantages. Some of the advantages derive directly from the reagents themselves. Titanium boride is a solid state material belonging to the class of materials know as the metal borides. The metal borides as a group typically exhibit enormous thermal and oxidative stability and are resistant to attack in even the harshest chemical environments, such as dilute acids, bases, molten salts, and even concentrated mineral acids. Many borides are even resistant to molten metals. For example, TiB₂ is completely resistant to acids, bases, and molten metals such as Al, Cu, Mg Sn, Bi, Zn and Pb. These compounds often can be heated in air to 1200° to 1400° C. without significant oxidation.

The chemical properties, and especially the safety features, of titanium diboride are particularly useful in connection with the flameless heating system of the present invention. Titanium diboride [CAS Number 12045-63-5] is a gray, odorless, non-flammable solid that has no self-reacting properties. Importantly, it is not considered a toxic hazard and there is no reported evidence of carcinogenicity or exposure risk. It may be disposed of as a simple solid waste and is not a compound regulated by the Superfund Amendments and Reauthorization Act (SARA), also known as the Emergency Planning and Community Right to Know Act. Titanium metal itself is also generally considered to be physiologically inert. There are no reported cases in the literature where either titanium metal or titanium diboride has caused human intoxication and no chronic health effects have been recorded. Titanium diboride is used extensively in commercial applications such as cutting surfaces, conductive ceramics, and as physical and corrosion protection materials.

Titanium boride is currently inexpensive (ca. <$0.40 per gram) and is readily available either from a variety of commercial sources in bulk or readily synthesized by a carbothermal method. Since the titanium boride employed in the present invention requires only small catalytic quantities, the cost of reagents per heating unit is very low. The present invention also encompasses methods for forming titanium boride materials as powders, pellets, or as thin film coatings, even on thermally sensitive substrates such as plastics. The thin film coating variety may be particularly important in the inexpensive fabrication of readily reusable heating units.

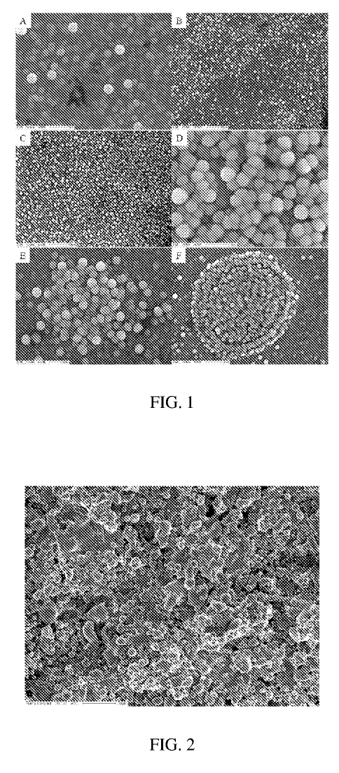

In formulating the titanium boride catalyst, metal boride materials can be readily synthesized by bulk carbothermal, CVD, aerosol, and spray pyrolytic methods. Carbothermal methods are very straightforward and have been known for decades for forming high purity bulk ceramic and powdered materials. Highly crystalline pure titanium boride thin film coatings may be readily prepared using CVD, aerosol, and spray pyrolytic methods, as seen in FIG. 1. More specifically, FIG. 1 details aerosol deposited film formed from TiC14 and decaborane(14) in acetonitrile at 900° C.

Referring to FIG. 2, the boride formed by aerosol methods, as seen in scanning electron microscopy (SEM), contains uniform, well-formed spherical products. Boride formed by aerosol methods results in spheres having very clear boundaries, with an average size of 1.02 μm with a standard deviation of 0.16 μm. Using pyrolytic methods for forming boride-containing coatings on substrates, including thermally sensitive substrates (plastics, Teflon, kapton, glass, etc.), offers an economically and experimentally viable pathway to provide coatings with the unparalleled chemical and physical properties of the boride materials required for the proposed heating technology.

The other major component of our the present invention is a hydrogen peroxide solution. A 3% - 10% aqueous hydrogen peroxide solution is a very safe, convenient and inexpensive material to use. These solutions are colorless, odorless, and non-flammable with no significant health hazards under normal conditions of use. No adverse effects are to be expected from skin contact, ingestion (except in very large oral doses), or through inhalation (direct eye and open wound contact, however, should be avoided and may result in irritation). In fact, these solutions are often used in the household as mouthwashes, germicides, food preservatives, laundry additives, and bath additives, among many other uses. These solutions are stable for long term storage and may be easily used and disposed, typically by flushing down the drain. They are also very inexpensive (ca. <$ 1 per liter) and are readily obtained in very large quantities commercially. Additionally, higher concentration solutions are also readily available and may be diluted prior to use, thereby reducing the weight load of the heating units even further, if desirable.

Together, the chemical properties of the two-reagent system of solid titanium boride and dilute aqueous hydrogen peroxide form a convenient, inexpensive and efficient chemical system for application to flameless heating according to the present invention.

While titanium boride is insoluble and unreactive in essentially all common solvents, it will surprisingly dissolve in aqueous solutions of hydrogen peroxide. This process occurs with the liberation of a significant amount of heat. For example, the addition of 0.02 mol of TiB₂ to 100 mL of dilute 4% aqueous hydrogen peroxide liberates 1493 kJ/mole. Stated another way, 1.4 g of TiB₂ added to 100 mL of 4% aqueous hydrogen peroxide will heat the solution to 87° C. (188° F.) and form a gel. Decreasing the peroxide concentration to 3% liberates 1226 kJ/mol or heated the 100 mL of solution to 81° C. (178° F.) in 10 minutes. Upon addition of the titanium boride catalyst to the solution a soft gel rapidly forms. This is particularly important because this gel provides a uniform and controlled release of the heat to anything in contact with the gel. Evaporation of the solvent provides the starting titanium boride material back in a smaller amount than used initially, mixed with some boric acid and a small amount of uncharacterized amorphous material.

Table 1 below provides the time for various amounts of TiB₂ to reach a maximum temperature.

TABLE 1

| Max. Temp. | TiB₂ Amt. | Time to Max. Temp. |
|---|---|---|
| 58° C. (136° F.) | 0.010 mol | 22:50 min. |
| 72° C. (162° F.) | 0.015 mol | 19:33 min. |
| 76° C. (169° F.) | 0.020 mol | 14:00 min. |
| 81° C. (178° F.) | 0.030 mol | 10:15 min. |

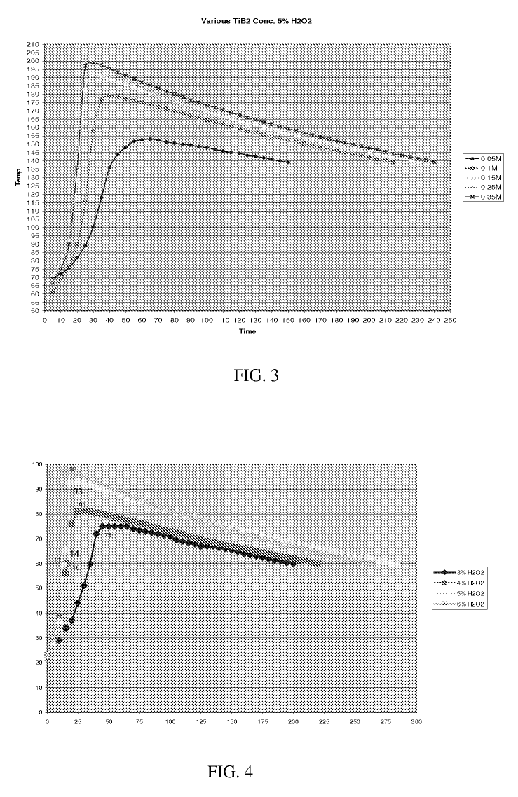

The ultimate temperature that the system achieves depends upon the amount of TiB₂ employed. For example, by employing 100 mL of a 3% hydrogen peroxide solution, the relationship between the amount of titanium boride used and temperature parameters as a function of time can be seen in FIG. 3, which depicts the heating profiles for 500 mL of a 5% hydrogen peroxide solution as a function of titanium boride concentration (no stirring). By varying amounts of titanium boride the heating profile can be tailored to the intended use of the flameless heating system for specific circumstances.

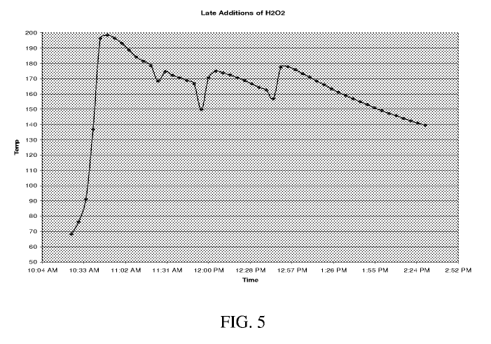

The reaction can also be controlled by varying the concentration of the starting peroxide solution. This can be advantageous as lower heating temperatures and slower times may be needed for some applications. The curves and temperatures for these experiments are seen in FIG. 4, which shows the heating profiles for 500 mL of a solution with 0.2 M titanium boride as a function of hydrogen peroxide concentration (no stirring). The fundamental chemistry of this reaction system appears to involve titanium boride catalytically decomposing the hydrogen peroxide into water and oxygen (equation shown above).

In cases where no gel is formed, the O₂ is liberated by bubbling from the reaction solution. This can be conveniently released by simple venting, using a Gortex check valve, or by a similar gas-venting arrangement. In the cases where a gel is formed, however, most of the oxygen seems to be trapped by the titanium boride in solution to crosslink the boride structural units to form the observed gel. This effectively prevents rapid outgassing of the oxygen. Thus, the only products of the reaction are the formation of water and O₂.

While the present invention does not evolve heat when used with other simple metal catalyst systems, the catalytic system of the present invention works well in non-aqueous solvents, such as ethylene glycol. Titanium boride may be recovered by evaporation of the reaction solution, and the addition of fresh hydrogen peroxide solution yields the heat as obtained initially with a slight loss of maximum temperature achieved at a slightly slower rate. Thus, the titanium boride may be reused to some extent.

A rechargeable unit may be achieved by simply removing the exhausted peroxide solution and recharging the unit with a fresh solution (the exhausted peroxide does not necessarily need to be removed.) Alternatively, designing a system in which periodically additional quantities of peroxide are added can maintain the heating advantage for longer periods of time. FIG. 5 depicts a heating curve in which several aliquots of peroxide are added at varying times. More specifically, FIG. 5 shows the heating profiles for 500 mL of a 5% hydrogen peroxide solution with 0.2 M titanium boride (no stirring). At three locations, seen by the dips in the profile after the initial maximum was achieved, additional aliquots of 30% peroxide were added (10 mL, 20 mL and 20 mL, as viewed from left to right in FIG. 5). Upon each addition, the temperature of the system increases, thereby extending the heating usefulness of the system as long as reasonably desired.

The gel obtained from a reaction according to the present invention is rather viscous, although it conforms well to a molded shape such as a UGR tray, and is easily contained. Since any residual peroxide and titanium boride are non-toxic, disposal is not a significant problem.

This flameless heating system of the present invention is useful for a variety of application, including but not limited to: (1) heating or maintaining the temperature of food services (e.g., catering); (2) heating cold meals, beverages, soups, etc. in the field; (3) heating medical compresses, sterilizing devices, and body warmers, (4) survival blankets, and (5) cleaning products, among many other possible applications. The flameless heating unit of the present invention thus provide a number of significant potential advantages as flameless heating units, including: the use of safe, inexpensive, and readily stored reagents (titanium boride and peroxide solutions); the formation of only water and trapped O₂ as reaction by-products; the formation of a gel that provides ready heat exchange and prevents mess in the operation and disposal of the unit; non-flammability at all stages of operation; the liberation of large amounts of energy; self-regulated heat generation; the possibility of re-useable units by employing titanium boride thin film coatings in the heating unit, and easy operation and disposal.

What is claimed is:

1. A flameless heating composition of matter, comprising:
a. an aqueous peroxide solution; and
b. a catalyst composed of titanium boride materials.

2. The flameless heating composition of matter according to claim 1, wherein said titanium boride materials is solid and in the form selected from the following group: a pellet, a powder, or a thin film coating on a substrate.

3. The flameless heating composition of matter according to claim 2, wherein said substrate is composed of plastic.

4. The flameless heating composition of matter according to claim 1, wherein said aqueous peroxide solution is a 3% - 10% hydrogen peroxide solution.

5. A method for forming a rechargeable flamelesss heating system comprising the steps of:
a. providing an aqueous peroxide solution;
b. adding a catalyst composed of titanium boride materials to said peroxide solution, thereby forming a flameless heating composition; and
c. periodically adding quantities of aqueous peroxide solution to said flameless heating composition.

6. The method according to claim 5, comprising the further step of removing exhausted peroxide after a predetermined period of time after step b and prior to step c.

7. A method of forming a flameless heating composition of matter comprising the steps of:
a. providing an aqueous peroxide solution; and
b. adding a catalyst composed of titanium boride materials to said peroxide solution, thereby forming a flameless heating composition of matter.

8. The method according to claim 7, wherein said titanium boride materials is solid and in the form selected from the following group: a pellet, a powder, or a thin film coating on a substrate.

9. The method according to claim 8, wherein said substrate is composed of plastic.

10. The method according to claim 8, wherein said aqueous peroxide solution is a 3%-10% hydrogen peroxide solution.
